(19) United States
(12) Patent Application Publication
(10) Pub. No.: US 2025/0317203 A1
(43) Pub. Date: Oct. 9, 2025

(54) DYNAMIC ADAPTATIVE DETECTING METHODOLOGY FOR FIBER CONNECTIVITY ISSUES BY OPTICAL SIGNAL LOSS

(71) Applicant: AT&T Intellectual Property I, L.P., Atlanta, GA (US)

(72) Inventors: Chanhyun Kang, Holmdel, NJ (US); Jin Wang, Fremont, CA (US); Letian Chen, Chesterfield, MO (US); Yali Liu, Dublin, CA (US)

(73) Assignee: AT&T Intellectual Property I, L.P., Atlanta, GA (US)

(21) Appl. No.: 18/630,694

(22) Filed: Apr. 9, 2024

(51) Int. Cl. H04B 10/079

(52) U.S. Cl. CPC H04B 10/0795

(57) ABSTRACT

Aspects of the subject disclosure may include, for example, trained, rule based models used to predict whether fiber connections exist upstream of an optical terminal. A regression model is built using optical signal measurements at optical terminals and distances between the optical terminals and an upstream optical terminal. The regression model may be used to predict an optical signal level at an under-test optical terminal based on a distance between the under-test optical terminal and the upstream optical terminal. Other embodiments are disclosed.

### FIELD OF THE DISCLOSURE

The subject disclosure relates to signal losses in optical fiber connections.

### BACKGROUND

Customers of fiber network providers may generally assume that optical signal transmission over fiber networks is reliable, and that subscriber side optical signal levels do not experience much loss. However, practical implementations of fiber network connections to end-users may be susceptible to signal loss due to multiple factors (e.g., different implementation of fiber connectors & lines with heterogeneous network components). Additionally, end-user side optical signals may suffer serious degradation when the links between the network components have fiber connectivity issues such as improper connections with fiber connectors and/or abnormal or underperforming fiber network components.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIGS. 2B and 2C depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systematically detecting fiber connectivity issues between optical network components using rule-based models that take into consideration the relative placement of optical network components within the network. Other embodiments are described in the subject disclosure.

One or more aspects of the subject disclosure include a device, comprising a processing system including a processor; and a memory that stores executable instructions that, when executed by the processing system, facilitate performance of operations. The operations may include receiving optical signal level measurements from a plurality of optical terminals, wherein each of the plurality of optical terminals receive optical signals originating from an upstream optical terminal, and the optical signal level measurements correspond to signal levels of the optical signals originating from the upstream optical terminal; receiving distance values that represent distances between the upstream optical terminal and the plurality of optical terminals; performing a regression analysis using the optical signal level measurements and the distance values to produce a regression model; and comparing a first optical signal level measurement from an under-test optical terminal with a first predicted optical signal level produced by the regression model to predict whether optical fiber problems exist between the upstream optical terminal and the under-test optical terminal.

Additional aspects of the subject disclosure include the plurality of optical terminals comprising a plurality of customer premise optical terminals or a plurality of intermediate optical terminals, and/or the upstream optical terminal comprising a provider premise optical terminal or an intermediate optical terminal. The operations may further include performing an aggregation function on the optical signal level measurements to produce a second predicted optical signal level; and comparing the first optical signal level measurement with the second predicted optical signal level to predict an existence of a fiber problem upstream of the under-test optical terminal.

Additional aspects of the subject disclosure include the aggregation function comprising averaging the optical signal level measurements, selecting a maximum measurement from the optical signal level measurements, and/or any statistical function of the optical signal level measurements.

One or more aspects of the subject disclosure include a non-transitory machine-readable medium, comprising executable instructions that, when executed by a processing system including a processor, facilitate performance of operations. The operations may include receiving optical signal level measurements from a plurality of optical terminals, wherein each of the plurality of optical terminals receive optical signals originating from an upstream optical terminal, and the optical signal level measurements correspond to signal levels of the optical signals originating from the upstream optical terminal; performing an aggregation function on the optical signal level measurements to produce a first predicted optical signal level; and providing the first predicted optical signal level to field equipment for comparing a first optical signal level measurement from an under-test optical terminal with the first predicted optical signal level to predict an existence of a fiber problem upstream of the under-test optical terminal.

Additional aspects of the subject disclosure include embodiments in which the plurality of optical terminals, under-test optical terminal, and upstream optical terminal are any combination of optical network terminals (ONTs), flexible service terminals (FSTs), primary flexibility points (PFPs) or optical line terminals (OLTs). Further aspects of the subject disclosure include embodiments in which the aggregation function comprises averaging the optical signal level measurements and/or the aggregation function comprises selecting a maximum measurement from the optical signal level measurements.

One or more aspects of the subject disclosure include a method, that may comprise determining, by a processing system including a processor, a first expected signal level for an under-test optical network terminal (ONT), wherein the first expected signal level is determined by evaluating a regression model generated using measured signal levels from other ONTs; determining, by the processing system, a second expected signal level for the under-test ONT, wherein the second expected signal level is determined by evaluating a statistical function of the measured signal levels from the other ONTs; and providing, by the processing system, the first expected signal level and the second expected signal level to field equipment for comparison with a measured signal level from the under-test ONT.

Additional aspects of the subject disclosure include determining the first expected signal level from a distance between the under-test ONT and an optical line terminal (OLT), determining an average of the measured signal levels from the other ONTs, and/or determining a maximum of the measured signal levels from the other ONTs.

Optical signal loss levels of subscribers may vary significantly and dispatching technicians to troubleshoot these losses can be prohibitively expensive. The number of expensive technician dispatches can be significantly reduced if the first technician deployed for either installing new end-user side network components or fixing service issues completes the work without fiber connectivity issues which result in serious optical signal loss. Various embodiments described herein provide methods and apparatus to determine whether signal losses are acceptable in any given scenario, thereby potentially reducing expensive technician dispatches.

Various embodiments provide a methodology to detect fiber connectivity issues of subscriber side network components systematically by applying trained rule-based models, which can determine excessive fiber optical signal loss level of the network components while considering their relative network implementation. The methodology ascertains whether an end-user side network component, e.g., optical network terminal (ONT), flexible service terminal (FST), primary flexibility point (PFP) and the linked fiber connections are experiencing fiber connectivity issues or not, with respect to measured optical signal levels of optical network terminals (ONTs), expected optical signal levels based on (estimated) fiber lengths from optical line terminal (OLT) to ONTs, and achievable optical signal level of adjacent network components. Various embodiments include conditional rules having separately (trained) thresholds to define excess signal loss level of a network component absolutely and/or relatively taking into account the fiber structural neighbors of the component.

Various embodiments may provide a proactive indication of fiber connectivity issues which may likely need a technician dispatch to fix the issue later. It enables initially deployed technicians to make subscriber side network implementations properly to avoid fiber connectivity issues and to prevent unnecessary technician dispatches later, thereby saving costs.

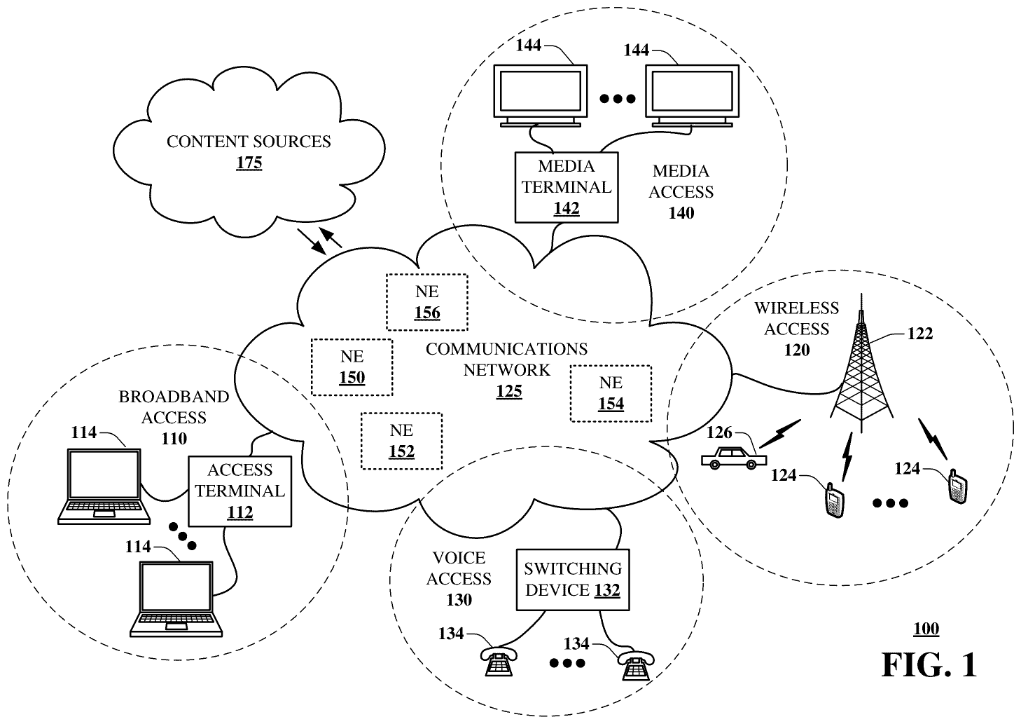

Referring now to FIG. 1, a block diagram is shown illustrating an example, non-limiting embodiment of a system 100 in accordance with various aspects described herein. For example, system 100 can facilitate in whole or in part the application of trained rule-based models to detect fiber connectivity issues of subscriber side network components. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

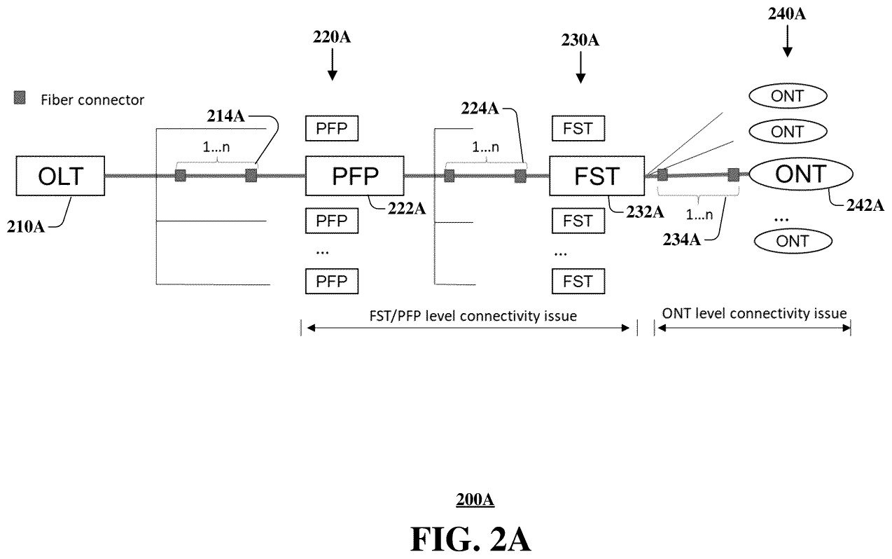

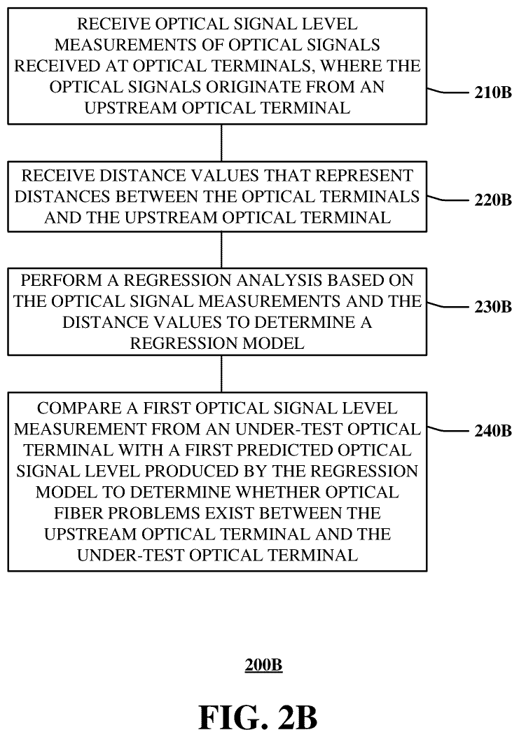

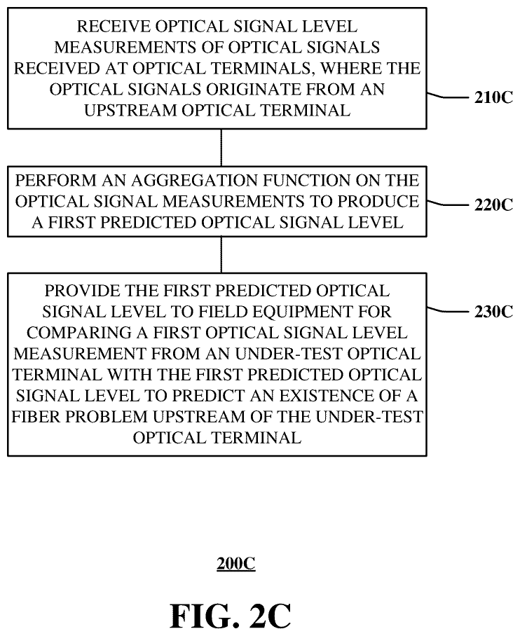

FIG. 2A is a block diagram illustrating an example, non-limiting embodiment of a system 200A functioning within the communication network of FIG. 1 in accordance with various aspects described herein. System 200A shows fiber connections from an OLT 210A to the ONTs 240A as a tree structure. The top/root node is the OLT 210A, and the bottom/leaf nodes are ONTs 240A. PFPs 220A and FSTs 230A are the intermediate nodes between them.

In embodiments represented by FIG. 2A, OLT 210A represents an optical terminal on a provider's premises. For example, OLT 210A may be an optical line terminal within communications network 125 (FIG. 1). Also in embodiments represented by FIG. 2A, ONTs 240A represent optical network terminals at customers' premises. In some embodiments, each of ONTs 240A is a terminal located at an end user site (e.g., on the side of a house, commercial building, or other end point installation). PFPs 220A and FSTs 230A represent terminals in the tree structure that provide connections between OLT 210A and ONTs 240A. As shown in FIG. 2A, FSTs 230A are upstream from ONTs 240A, PFPs 220A are upstream from FSTs 230, and OLT 210A is upstream from PFPs 220A.

Any terminal upstream of an optical terminal, regardless how many connections exist between them, may be referred to as an upstream optical terminal. For example, OLT 210A, PFPs 220A, and FSTs 230A are all upstream optical terminals with respect to ONTs 240A. Similarly, OLT 210A and PFPs 220A are upstream optical terminals with respect to FSTs 230A, and OLT 210 is an upstream optical terminal with respect to PFPs 220A. Conversely, any terminal downstream of an optical terminal, regardless how many connections exist between them, may be referred to as a downstream optical terminal. For example, ONTs 240A, FSTs 230A, and PFPs 220A are all downstream terminals with respect to OLT 210A. Similarly, ONTs 240A and FSTs 230A are downstream terminals with respect to PFPs 220A, and OLT 210A, ONTs 240A are downstream terminals with respect to FSTs 230A, PFPs 220A, and OLT 210A.

FIG. 2A shows a simplified hierarchical fiber connection structure from one OLT 210A to many ONTs 240A. The fiber line between a parent node to a child node may have multiple fiber connector(s) to connect two components of the fiber network. For example, the fiber line between OLT 210A and PFP 222A may include many fiber connections 214A, the fiber line between PFP 222A and FST 232A may include many fiber connections 224A, and the fiber line between FST 232A and ONT 242A may include many fiber connections 234A. Similarly, the fiber lines between OLT 210A and the remaining PFPs 220A may include many connections, the fiber lines between the various PFPs 220A and their child node FSTs 230A may include many connections, and the fiber lines between the various FSTs 230A and their child node ONTs 240A may include many connections.

When a fiber line or its associated connections between two network component nodes is not well established and/or maintained, the optical signal between them may become deteriorated. If the signal degradation of fiber connections is significant, the network performance experience of end-users over the lines may be poor, leading to expensive technician dispatches. As described above, expensive technician dispatches may be reduced when, during install or service, end-user side fiber implementations are completed without significant fiber signal loss and are maintained at proper achievable optical signal levels. From a deployed technician's perspective, this is a hard problem to solve, in part because it may be difficult to determine whether an optical signal level measured at a particular optical terminal is appropriate for a given implementation. Additionally, it may not be easy to figure out which connections and/or components are experiencing issues because signal degradation may result from any parent optical terminals or upstream optical terminals as well as connections between these optical terminals.

Various embodiments described herein determine expected or predicted optical signal levels at various optical terminals considering many factors of fiber networks, (e.g., lengths for fiber connections between optical terminals, different numbers of connectors between optical terminals, heterogenous fiber components between optical terminals, etc.). Various embodiments described herein employ a set of (trained) rules to estimate ONT and FST/PFP received optical signal levels, and to predict the existence of fiber connectivity issues or optical terminal problems upstream of the optical signal measurements. Each rule may have a separate threshold value to define excess signal loss level of a network component level. In some embodiments, the threshold values of the rules are trained/set up for relatively homogeneous fiber components/structures which may have similar optical signal degrading effect(s) in general.

A first rule may be: If a received optical signal level at an optical terminal is less than a certain threshold, then optical fiber problems may exist upstream of the optical terminal. As used herein, the term “optical fiber problems,” “connectivity issues,” and the like may encompass issues with optical fiber material, connectors that splice optical fiber material, and/or operation of upstream optical terminals. The first rule may be stated as:

IF OT_RX_SIG of an OT<a certain threshold (81), THEN the OT may have fiber connectivity issue(s).

Where OT_RX_SIG is the measured optical signal level of an under-test optical terminal, OT is an optical terminal that is the under-test optical terminal, and δ₁ is the threshold.

In some embodiments, the threshold value δ₁ may be determined by starting with a known transmit (or receive) optical signal level of an upstream optical terminal. For example, if ONT 242A is the under-test optical terminal, the threshold may be determined based on a known receive power level of upstream optical terminal FST 232A. Also for example, if ONT 242A is the under-test optical terminal, the threshold may be determined based on a known receive power level of upstream optical component PFP 222A. Continuing with this example, if ONT 242A is the under-test optical terminal, the threshold may be determined based on a known transmit power level of upstream optical component OLT 210A.

In some embodiments, the threshold value may be determined based on the known transmit or receive power level of an upstream optical terminal reduced by a factor that takes into account the number and/or type of fiber connections between the upstream optical terminal and the under-test optical terminal. For example, when testing the received optical signal level at ONT 242A, a threshold based on a known receive power level at FST 232A may be reduced by a factor that takes into account fiber connections 234A. Also for example, when testing the received optical signal level at ONT 242A, a threshold based on a known receive power level at PFP 222A may be reduced by a factor that takes into account fiber connections 224A and fiber connections 234A. Continuing with this example, when testing the received optical signal level at ONT 242A, a threshold based on a known transmit power level of OLT 210A may be reduced by a factor that takes into account fiber connections, 214A, fiber connections 224A, and fiber connections 234A.

A second rule may determine, and make use of, a regression model. For example, a regression model may be determined from: 1) optical signal level measurements of devices at the same “level” in the hierarchy, optical signal level measurements (or known transmit/receive power levels) of an upstream optical terminal, and 2) distances between the upstream optical terminal and devices at the same level downstream in the hierarchy from which the measurements were taken. As an example, a regression model may be built using optical signal level measurements of received signals at each of the ONTs 240A (with the possible exception of ONT 242A in this example), and the distances between ONTs 240A and OLT 210A. A linear regression model may determine a slope (p) and an intercept (e), and may be in the form of:

e+OLT_TX_SIG−p×l,
Where OLT_TX_SIG is the transmitted optical signal level at the upstream optical terminal (e.g., OLT 210A), l is the distance between the upstream optical terminal and the under-test optical terminal (e.g., ONT 242A), and e and p are features of the regression model, where p represents an optical signal degrading ratio per distance 1, and e represents the general signal loss of the ONTs connected to the OLT from fiber connections.

In some embodiments, the regression model captures the expected optical signal loss from the OLT to the child ONTs based on the distances between ONTs to the OLT, and the structural fiber network connections. If the signal loss measured at the under-test optical terminal (e.g., ONT 242A) is significantly more than other ONTs under the same OLT (as a function of distance), then it may be determined that the under-test optical terminal may have fiber connectivity issues. In some embodiments, an expected (or predicted) optical signal level at the under-test optical terminal (e.g., ONT 242A) may be determined using the regression model as:

EXP_ONT_RX_SIG=e+OLT_TX_SIG−p×l

Where EXP_ONT_RX_SIG is the expected received optical signal level at the under-test optical terminal, and l is the distance between the upstream optical terminal and the under-test optical terminal.

The second rule may be stated as: For a given under-test optical terminal (e.g., ONT) and an upstream optical terminal (e.g., OLT) connected to the under-test optical terminal, if the difference between the expected received optical signal level (EXP_ONT_RX_SIG) as determined by a regression model, and the measured optical signal level (ONT_RX_SIG) at the under-test optical terminal is greater than a certain threshold (82), then the under-test optical terminal may have fiber connectivity issue(s).

In some embodiments, the regression model is continuously trained and/or updated. For example, ONTs 240A may continuously report measured optical signal power levels to a system such as a network element within communications network 125 (FIG. 1). With knowledge of the distances between OLT 210A and each of the ONTs within ONTs 240A, the network element may continually update the regression model based on changes in the measured optical signal levels at the various ONTs 240A.

The previous example describes determining a regression model using known transmit power levels at OLT 210A, measured optical signal levels at ONTs 240A, and the distances between them. In some embodiments, one or more regression models are built using measured optical signal levels at other levels within the hierarchy and the associated distances. For example, a regression model may be built using received power levels at FSTs 230A, known transmit power levels at OLT 210A, and the distances between them, and this regression model may be used when installing or testing an FST (e.g., FST 232A) at the same level in the hierarchy to determine if there are fiber connectivity issues. Other upstream signal measurements may be used as well. For example, a received power level at PFP 222A may be used to train a regression model using measured optical signal levels at either FSTs 230A or ONTs 240A. In general, a regression model may be built using transmit or receive power levels and distances between any two levels in the hierarchy. Similarly, an under-test optical terminal may be at any level of the hierarchy, including any of PFPs 220A, FSTs 230A, and ONTs 240A.

A third rule may estimate fiber connectivity issues of an under-test optical terminal (e.g. ONT 242A) when the under-test optical terminal has a relatively lower OT_RX_SIG than the other optical terminals connected to a same upstream optical terminal (e.g., FST 232A). An example is now provided in which the under-test optical terminal is an ONT and the upstream terminal an FST. For each FST, an optimal FST received optical signal level (FST_OPT_RX) is determined based on OT_RX_SIG of ONTs connected to the FST. The optical signal level of the FST represents the achievable received optical signal level of ONTs under the FST in recent or certain period(s), which can be defined as an aggregated value of OT_RX_SIGs of the ONTs in the period(s). For example, the FST_OPT_RX for an FST in a period=aggr(ONT_RX_SIG of ONTs connected to the FST in the period), where the aggregation function, (aggr), can be any function of the received optical signal levels, including a statistical function, a maximum, an average, a median, a certain percentile, etc.

The third rule may be stated as: For a given under-test optical terminal and the upstream optical terminal connected to it, if (OT_RX_SIG of the under-test optical terminal minus the optimal received optical signal level based on the upstream optical terminal is less than a certain threshold (δ₃), then the under-test optical terminal may have fiber connectivity issues.

In the above example, the under-test optical terminal is an ONT and the upstream terminal an FST. In some embodiments, a rule may be used to estimate fiber level connectivity issues between intermediate optical terminals (e.g., between FSTs 230A and PFPs 220A). For example, a fourth rule may estimate FST/PFP level fiber connectivity issues. For each PFP, we define an optimal PFP received optical signal level (PFP_OPT_RX) based on FST_OPT_RXs of the FSTs connected to the PFP. It can be defined by an aggregated value of the FST_OPT_RXs, which captures the achievable signal level over the child ONTs connected to the PFP through the FTSs. For example, PFP_OPT_RX=aggr(FST_OPT_RX of FSTs connected to the PFP), where the aggregation function, (aggr), can be any function of the received optical signal levels, including a statistical function, a maximum, an average, a median, a certain percentile, etc. In this example, the fourth rule is applied as follows: If FST_OPT_RX of a FST<a certain threshold (δ₄), then the FST and the ONT connected to FST may have fiber connectivity issues.

Similarly, a fifth rule may also be used to estimate fiber level connectivity issues between optical terminals (e.g., between FSTs 230A and PFPs 220A). The fifth rule may compare a difference between the optimal receive signal levels at two intermediate levels in the hierarchy to a threshold to determine whether connection issues exist. As an example, the fifth rule may be stated as: For a given FST and the PFP connected to the FST, if (FST_OPT_RX−PFP_OPT_RX)<a certain threshold (δ₅), then the FST may have fiber connectivity issues.

The methodology can determine fiber connectivity issues of end-user side network components and fiber connections easily by applying the rules systematically with maintaining small number of variables defined. It can be implemented easily to detect and prevent the issues proactively before end-users may experience (very) poor network performance from inadequate installation of end-user side network components. It can also provide supplementary information to help the technicians working to find a solution(s) to end-user side issues.

FIG. 2B depicts an illustrative embodiment of a method in accordance with various aspects described herein. The methods described with reference to FIG. 2B may be performed by any suitable processing apparatus, including for example a network element within a communications network, a server at a service provider's premises, a cloud server, or the like.

At 210B of method 200B, the apparatus performing the method receives optical signal level measurements of optical signals received at optical terminals, where the optical signals originate from an upstream optical terminal. In some embodiments, this corresponds to optical network terminals 240A (FIG. 2A) measuring optical signals received from upstream optical terminals (e.g., FST 232A, PFP 222A, or OLT 210A), and reporting the measured optical signal levels.

At 220B, the apparatus performing the method receives distance values that represent distances between the optical terminals and the upstream optical terminal. In some embodiments, this corresponds to the apparatus receiving distances between ONTs 240A and an upstream optical terminal. At 230B, a regression analysis is performed based on the optical signal measurements and the distance values to determine a regression model. For example, in the example of optical signal measurements performed at ONTs 240A and the upstream optical terminal is OLT 210A, the regression analysis performs a curve fit using the optical signal measurements at ONTs 240A and the distances between the ONTs 240A and OLT 210A to determine the regression model.

At 240B, a first optical signal level measurement from an under-test optical terminal is compared with a first predicted optical signal level produced by the regression model to determine whether optical fiber problems exist between the upstream optical terminal and the under-test optical terminal. As used herein, the term under-test optical terminal refers to any optical terminal that is measuring its received optical signal level, or having its received optical signal level measured. For example, in some embodiments, an optical network terminal such as ONT 242A terminal may be an under-test optical terminal when is being installed, or when it is being tested to troubleshoot performance issues. Also for example, in some embodiments, a flexible service terminal such as FST 232A may be an under-test optical terminal when it is being installed, or when it is being tested to troubleshoot performance issues. Also for example, in some embodiments, a primary flexibility point such as PFP 222A may be an under-test optical terminal when it is being installed, or when it is being tested to troubleshoot performance issues.

Taking the example of ONT 242A being the under-test optical terminal and OLT 210A being the upstream optical terminal, the actions at 240B correspond to comparing an optical signal level measurement of a received optical signal at ONT 242A with a predicted optical signal level that is produced by a regression model. The predicted optical signal level may be produced by the regression model as a function of the distance between ONT 242A and OLT 210A. Further, the regression model is built using received optical signal levels measured at other optical network terminals at the same level of the network hierarchy as ONT 242A and distances between the other optical network terminals and OLT 210A.

Any optical terminal may be the under-test optical terminal, and any optical terminal may be the upstream optical terminal. For example, any of ONTs 240A, FSTs 230A, or PFPs 220A may be an under-test optical terminal during installation or when troubleshooting a problem. Also for example, any optical terminal that is upstream of the under-test optical terminal may be considered the upstream optical terminal in method 200B. For example, when one of ONTs 240A is an under-test optical terminal, the upstream optical terminal may be any of FSTs 230A, PFPs 220A, or OLT 210A. Similarly, when one of FSTs 230A is the under-test optical terminal, any of PFPs 220A or OLT 210A may be the upstream optical terminal. Also similarly, when one of PFPs 220A is the under-test optical terminal, OLT 210A may be the upstream optical terminal.

In some embodiments, the comparison described at 240B may be performed by a piece of field equipment that has been provided the regression model and or the predicted optical signal level from the regression model. Also in some embodiments, the comparison described at 240B may be performed by a server or network function that also performs the actions of 210B, 220B, and 230B. In these embodiments, a piece of field equipment may perform the optical signal level measurement at 240B and provide it to the server or network function to perform the comparison. Further, in some embodiments, when an ONT is the under-test optical terminal, the ONT may measure its received signal level and report it to the server or network function which then performs the comparison.

FIG. 2C depicts an illustrative embodiment of a method in accordance with various aspects described herein. The methods described with reference to FIG. 2C may be performed by any suitable processing apparatus, including for example a network element within a communications network, the server at a service provider's premises, a cloud server, or the like.

At 210C of method 200C, the apparatus performing method 200C receives optical signal level measurements of optical signals received at optical terminals, where the optical signals originate from an upstream optical terminal. This is described above with reference to the actions of 210B in method 200B.

At 220C, an aggregation function is performed on the optical signal measurements to produce a first predicted optical signal level. The aggregation function may be any function including a statistical function, an average, a mean, a selection of one signal level, or the like. As an example, optical signal levels may be received from each of ONTs 240A, and the measured signal levels may be averaged to produce the first predicted optical signal level at 220C.

AT230C, the first predicted optical signal level is provided to field equipment for comparing a first optical signal level measurement from an under-test optical terminal with the first predicted optical signal level to predict an existence of a fiber problem upstream of the under-test optical terminal. In some embodiments, this may correspond to a server at a service provider's premises providing the first predicted optical signal level to a piece of field equipment that is measuring an optical signal level of an optical terminal in the field. As an example, a technician may be installing or troubleshooting FST 232A, and the field equipment may measure a received optical signal power at FST 232A. The field equipment receives the predicted optical signal level (which was produced as an aggregation function of the optical signal measurements of the remaining FSTs 230A) and performs the comparison.

While for purposes of simplicity of explanation, the respective processes are shown and described as a series of blocks in FIGS. 2B and 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

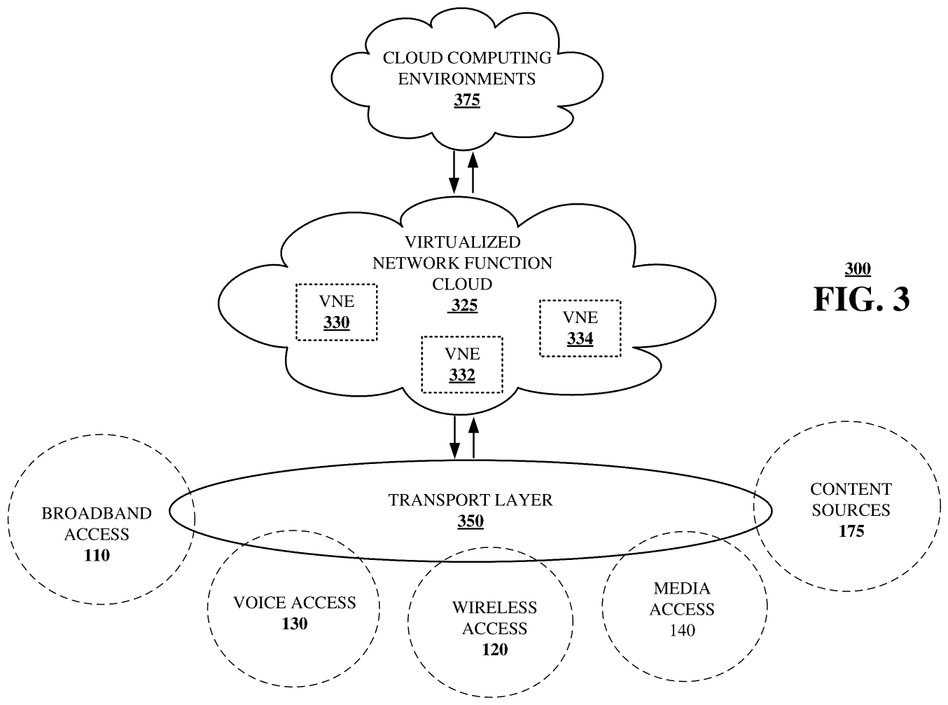

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions described herein. For example, virtualized communication network 300 can facilitate in whole or in part the application of trained rule-based models to detect fiber connectivity issues of subscriber side network components.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers, and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

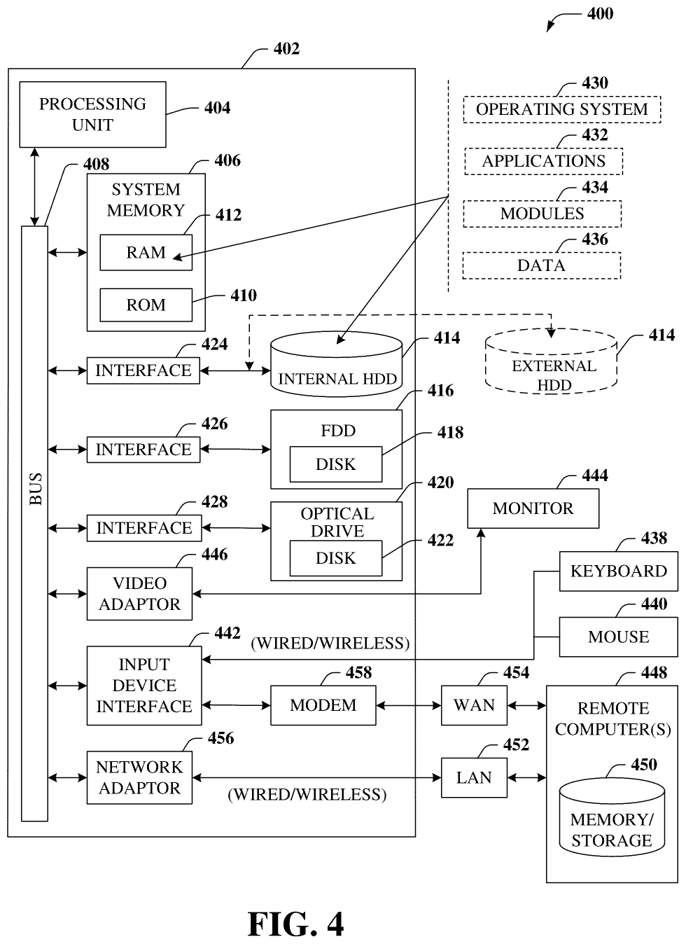

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the application of trained rule-based models to detect fiber connectivity issues of subscriber side network components.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory”herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

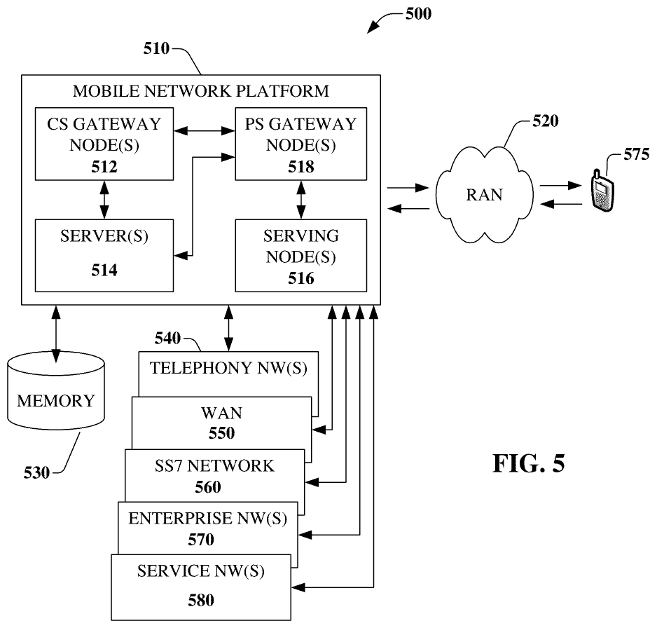

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part the application of trained rule-based models to detect fiber connectivity issues of subscriber side network components. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

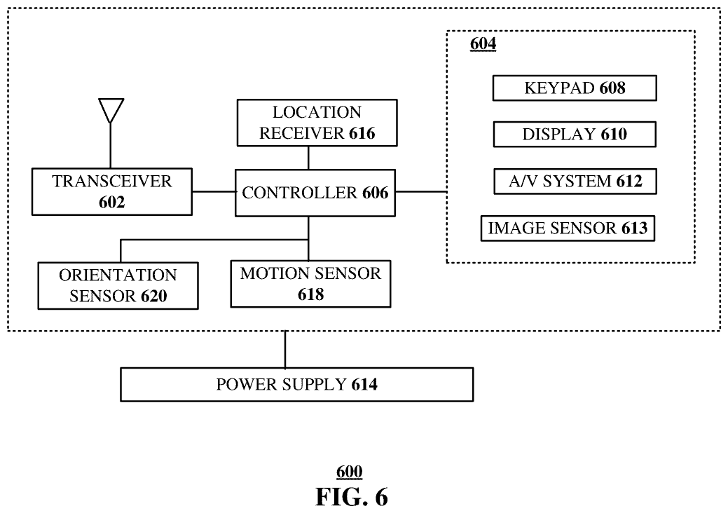

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part the application of trained rule-based models to detect fiber connectivity issues of subscriber side network components.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving optical signal level measurements from a plurality of optical terminals, wherein each of the plurality of optical terminals receive optical signals originating from an upstream optical terminal, and the optical signal level measurements correspond to signal levels of the optical signals originating from the upstream optical terminal;
receiving distance values that represent distances between the upstream optical terminal and the plurality of optical terminals;
performing a regression analysis using the optical signal level measurements and the distance values to produce a regression model; and
comparing a first optical signal level measurement from an under-test optical terminal with a first predicted optical signal level produced by the regression model to predict whether optical fiber problems exist between the upstream optical terminal and the under-test optical terminal.

2. The device of claim 1, wherein the plurality of optical terminals comprises a plurality of customer premise optical terminals.

3. The device of claim 1, wherein the plurality of optical terminals comprises a plurality of intermediate optical terminals.

4. The device of claim 1, wherein the upstream optical terminal comprises a provider premise optical terminal.

5. The device of claim 1, wherein the upstream optical terminal comprises an intermediate optical terminal.

6. The device of claim 1, wherein the operations further comprise:
performing an aggregation function on the optical signal level measurements to produce a second predicted optical signal level; and
comparing the first optical signal level measurement with the second predicted optical signal level to predict an existence of a fiber problem upstream of the under-test optical terminal.

7. The device of claim 6, wherein the aggregation function comprises averaging the optical signal level measurements.

8. The device of claim 6, wherein the aggregation function comprises selecting a maximum measurement from the optical signal level measurements.

9. A non-transitory machine-readable medium, comprising executable instructions that, when executed by a processing system including a processor, facilitate performance of operations, the operations comprising:
receiving optical signal level measurements from a plurality of optical terminals, wherein each of the plurality of optical terminals receive optical signals originating from an upstream optical terminal, and the optical signal level measurements correspond to signal levels of the optical signals originating from the upstream optical terminal;
performing an aggregation function on the optical signal level measurements to produce a first predicted optical signal level; and
providing the first predicted optical signal level to field equipment for comparing a first optical signal level measurement from an under-test optical terminal with the first predicted optical signal level to predict an existence of a fiber problem upstream of the under-test optical terminal.

10. The non-transitory machine-readable medium of claim 9, wherein the plurality of optical terminals comprises a plurality of optical network terminals (ONTs).

11. The non-transitory machine-readable medium of claim 10, wherein the under-test optical terminal comprises an ONT.

12. The non-transitory machine-readable medium of claim 11, wherein the upstream optical terminal comprises a flexible service terminal (FST).

13. The non-transitory machine-readable medium of claim 9, wherein the plurality of optical terminals and the under-test optical terminal comprise flexible service terminals (FSTs).

14. The non-transitory machine-readable medium of claim 13, wherein the upstream optical terminal comprises a primary flexibility point (PFP).

15. The non-transitory machine-readable medium of claim 9, wherein the aggregation function comprises averaging the optical signal level measurements.

16. The non-transitory machine-readable medium of claim 9, wherein the aggregation function comprises selecting a maximum measurement from the optical signal level measurements.

17. A method, comprising:
determining, by a processing system including a processor, a first expected signal level for an under-test optical network terminal (ONT), wherein the first expected signal level is determined by evaluating a regression model generated using measured signal levels from other ONTs;
determining, by the processing system, a second expected signal level for the under-test ONT, wherein the second expected signal level is determined by evaluating a statistical function of the measured signal levels from the other ONTs; and
providing, by the processing system, the first expected signal level and the second expected signal level to field equipment for comparison with a measured signal level from the under-test ONT.

18. The method of claim 17, wherein evaluating the regression model comprises determining the first expected signal level from a distance between the under-test ONT and an optical line terminal (OLT).

19. The method of claim 17, wherein the determining the second expected signal level comprises determining an average of the measured signal levels from the other ONTs.

20. The method of claim 17, wherein the determining the second expected signal level comprises determining a maximum of the measured signal levels from the other ONTs.
